(19) United States
(12) Patent Application Publication
(10) Pub. No.: US 2012/0192479 A1
(43) Pub. Date: Aug. 2, 2012

(54) Heated enclosure for killing bed bugs located within luggage

(76) Inventor: Jack D. Schmitz, Lake Havasu, AZ (US)

(21) Appl. No.: 12/931,345

(22) Filed: Jan. 31, 2011

(51) Int. Cl. A01M 1/00; A01M 1/20

(52) U.S. Cl. 43/132.1

(57) ABSTRACT

A heated enclosure for killing bed bugs located within luggage. A first rectangular housing has a roll up door located at the front. A second housing is attached to the side of the first housing. The second housing wall is vented to allow for the inflow of air. The first housing can retain a plurality of luggage items. A perforated vertical wall separates the first housing from the second housing. The first housing can accept plurality of wire form trays, each the tray capable of holding one or more items of luggage or suitcases. The second housing enclosing a plurality of heating elements and a plurality of tangential blower fan assemblies as well as a thermostat, a digital timer circuit, an LED display, an indicator light on off switch and safety switch. A power cord and plug provides power to the electrical components in the second housing.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of pest killing devices and more specifically to a heated enclosure for killing bed bugs located within luggage. Bed bugs have recently been making a re-appearance in recent years as a pest species that can inhabit bedding and bite people as they sleep. Sometimes these bugs find their way from the bedding and into items of clothing that may then be packed in a suitcase or other item of luggage.

It is known that beg bugs, from nymph to adult, can not withstand temperatures over 120 degrees F. It would therefore be in a person's best interest to heat a luggage item containing clothing to the desired kill temperature so that the bed bugs will not be accidentally brought from one environment to another. For example from a home environment to a hotel room or vice versa. There have obviously been, in the past, numerous specialty heating ovens designed for various purposes. For example W Metzger's U.S. Pat. No. 4,336,279 for curing coated substrates, or S Kiwokawa's U.S. Pat. No. 5,680,712 for drying objects.

However, no one to date has designed a heated enclosure specifically designed to hold a plurality of luggage items and to evenly heat those luggage items for a pre selected time and temperature for the purpose of killing bed bugs.

### BRIEF SUMMARY OF THE INVENTION

The primary object of the invention is to provide a heated enclosure that heats quickly to 120 degrees F. which is the temperature at which bed bugs are killed.

Another object of the invention is to provide a heated enclosure that can removably retain a plurality of suitcases and other luggage items.

Another object of the invention is to provide a heated enclosure that uses a plurality of heat sources to produce the most effective heat for killing bed bugs.

A further object of the invention is to provide a heated enclosure that uses one or more fans to draw air into the enclosure and to warm it and deliver it evenly throughout the enclosure.

Yet another object of the invention is to provide a heated enclosure that provides a means to horizontally place one or more shelves at various heights to hold luggage items.

Still yet another object of the invention is to provide a heated enclosure that includes an insulated roll up door to reduce space needed for operation.

Another object of the invention is to provide a heated enclosure that includes a timer to automatically shut off the heat sources and fans after a predetermined period.

Another object of the invention is to provide an adjustable brace that can hold the halves of a suitcase open so that heated air can more easily enter the suitcase.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a heated enclosure for killing bed bugs located within luggage comprising: a first rectangular housing, a roll up door located at the front of said first housing, a second housing, said second housing fixedly attached to the side of said first housing, at least one second housing wall being vented to allow for the inflow of air into said second housing, said first housing capable of removably retaining a plurality of luggage items, a perforated vertical wall separating said first housing from said second housing, said first housing having a plurality of post receiving receptacles fixedly attached and evenly spaced along said housing's inner side walls, said post receiving receptacles capable of receiving a plurality of wire form trays, each said tray capable of holding one or more items of luggage or suitcases, said second housing enclosing a plurality of heating elements and a plurality of tangential blower fan assemblies, said second housing also enclosing a thermostat, a digital timer circuit, an LED display, an indicator light, an on off switch, a safety shut off switch and a power cord and plug which provides power from a wall socket to said the said electrical components located within said second housing.

Said suitcases or said luggage items held partially open by means of one or more adjustable braces, the first end of said brace having a U shape and engaging the top edge of the side wall of the bottom half of said suitcase and the opposite end of said brace having a U shape that engages the bottom edge of the side wall of the top half of said suitcase, said brace body having two telescoping tubular members slidably locking together, one said tube having a standard spring biased bullet shape that engages one of a plurality of equally spaced apertures located in the said second tube allowing the length of said brace to be adjusted.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention.

FIG. 2 is a top plan view of the invention.

FIG. 3 is a left side view of the invention.

FIG. 4 is a front section view of the invention showing suitcases on the shelves of the main housing.

FIG. 5 is a side section view of the invention showing the second fan holding housing.

FIG. 6 is a side section view of the invention showing the main housing.

FIG. 7 is a side section view of a partially open suitcase held open by an adjustable brace.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

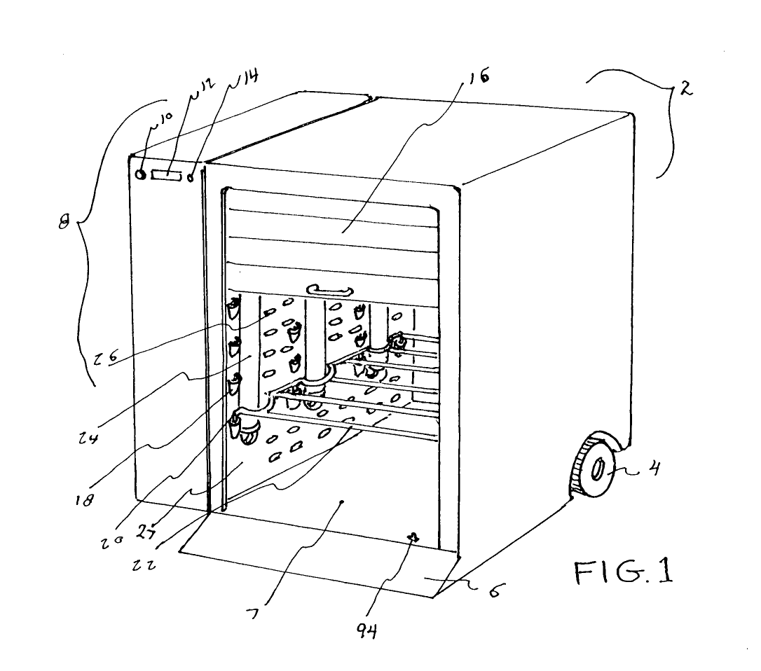

Referring now to FIG. 1 we see a perspective view of the invention, hereafter called the unit, with the roll up door 16 partially open. A main or first housing 2 is designed to hold one or more suitcases or pieces of luggage. In the preferred embodiment the main housing 2 is constructed of an outer shell of stainless steel or powder coated carbon steel. The inside walls are constructed of aluminum, to help with heat conduction. A heat resistant insulation is placed between the inner walls and the outer walls. The luggage can either be placed on the floor 7 of the housing or on racks 22. A plurality of racks 22 are supported by sockets 18 that removably receive rack posts 20. A series of evenly spaced sockets 18 allows the user to adjust the shelf height as needed depending on the size of luggage inserted into the main housing 2. A secondary housing 8 holds within it a fan system as well as heating elements. Heated air is blown into main housing 2 through apertures 26 in the common wall 27 that divides the first housing 2 from the second housing 8. Infra-red heating elements 24 provide instant heat when turned on via on-off switch 10. An indicator light 14 turns red when the unit is operating and green when the unit has finished its heating cycle. A digital display 12 tells the user how much time is left in the heating cycle. A set of rear wheels 4, 5 allow the entire unit to be tilted and rolled to any desired location. Ramp 6 allows heavy rolling luggage to be easily rolled into the interior of main housing 2.

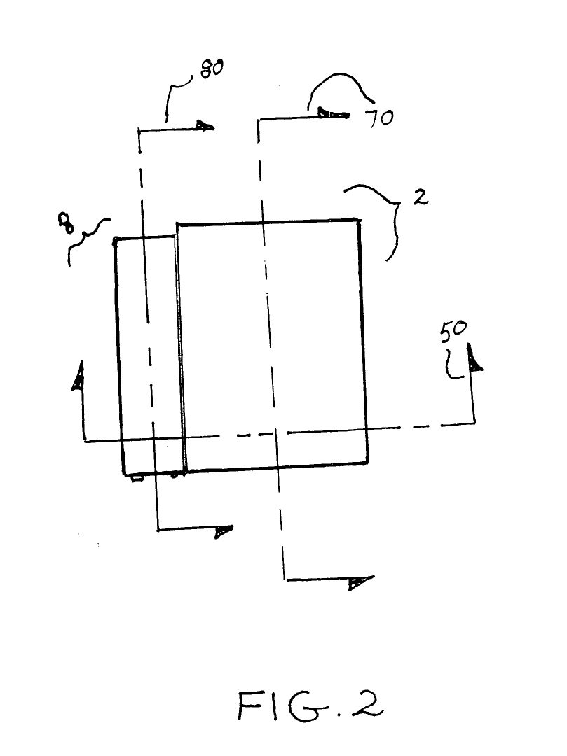

FIG. 2 shows a top plan view of the invention with section lines 50, 60, 70, 80, to help define section views shown in the Figures that follow.

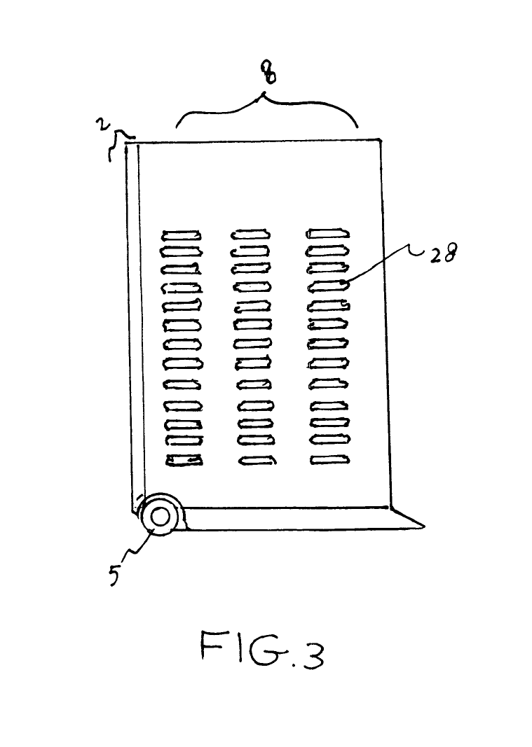

FIG. 3 is a left side view of the invention. A plurality of apertures 28 allow outside air to be drawing into the second housing 8. Second wheel 5 can be clearly seen in this view.

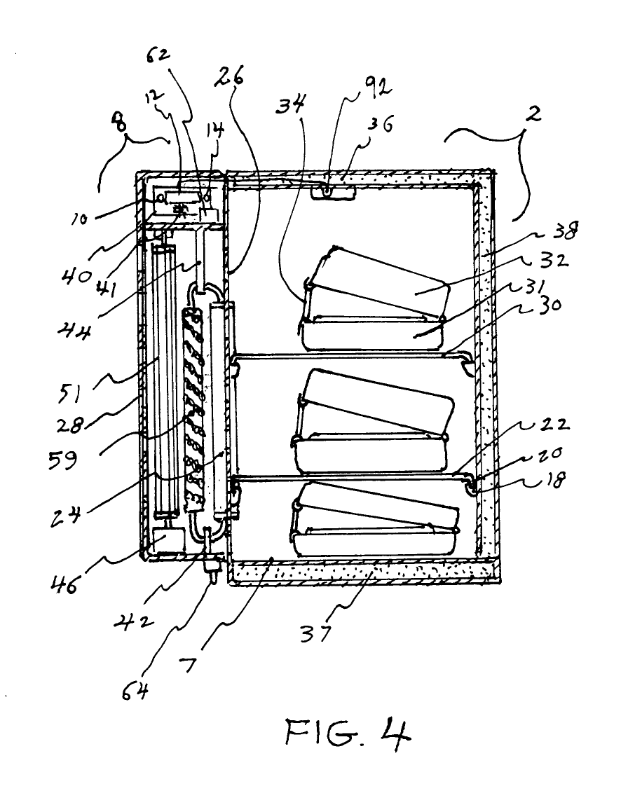

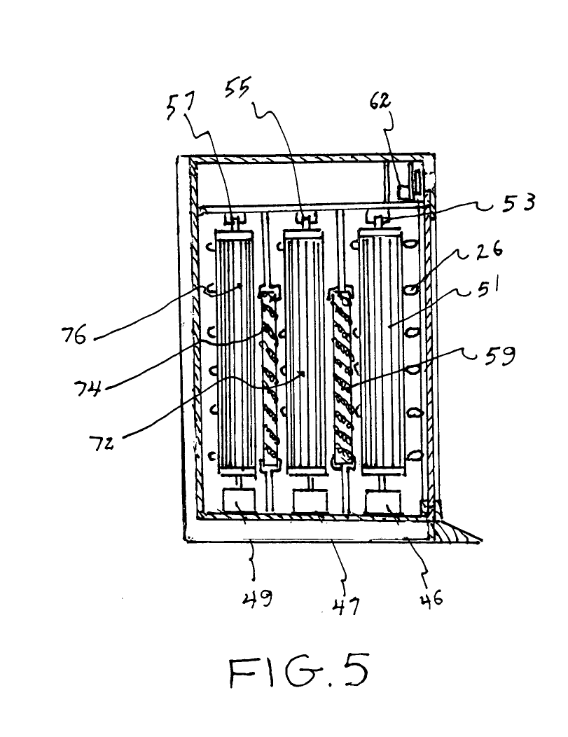

FIG. 4 is a section view as defined by section line 50. Second housing 8 contains within it one or more tangential fan blade assemblies 51 each rotationally powered by a standard AC motor 46. Other standard air moving assemblies may be used in place of the tangential fan blade assemblies 51. Infra-red heater 24 instantly heats items in close proximity to it and standard radiant heater 59 heats up more slowly but provides uniform consistent heat. Other potential heating elements used for this heating application include ceramic heaters and other commonly known heat producing elements. The heating elements are held in place by rigid brackets 42, 44. The infra-red heaters 24 reside partially inside main housing 2. The infra-red heating elements 24 heat items in close proximity, but are relatively safe if accidentally touched. Therefore they can be partially located within housing 2 without the danger of burning a user. Heat from radiant heaters 59, 72, 76, shown in FIG. 5, passes through the apertures 26 in the wall 27 that separates the second housing 8 from the main housing 2. In the preferred embodiment, the radiant heater 59 remains on at low power and maintains a temperature of ninety degrees, even when the unit is not in use. This heat setting allows the main housing 2 to be warmed to its in use operating temperature more quickly than if the interior of the housing were at room temperature. A standard light bulb 92 automatically turns on when roll up door 16 is lifted. The light is turned on when the spring biased, momentary, normally open floor switch 94 shown in FIG. 1 is activated. A printed circuit board 40 holds on off switch 10, digital display 14, indicator light 14 and microprocessor timing circuit 41. Thermostat 62 can also be seen in the same area. The thermostat 62 is set to between one hundred and twenty degrees F. and one hundred and thirty degrees F. This is the temperature range at which experiments have shown to be lethal to bed bugs. Yet the temperature is low enough as to not harm clothing or other items that may be stored in a typical suitcase or other luggage item. A standard suitcase is comprised of an upper half 32 and a lower half 31. The two halves are held in a partially open position by braces 34. This configuration allows the heat to more quickly and easily enter the interior recesses of the suitcase 31, 32 so that it may quickly kill any bed bugs that may be residing therein. The main housing is insulated 37, 38, 36, to help retain heat and make the overall unit more energy efficient. Tilt switch 64 automatically turns off power to the unit if the unit is accidentally pushed over.

FIG. 5 shows a side section view as defined by section line 80 in FIG. 2. This view shows the interior of second housing 8. In the preferred embodiment, three tangential fan assemblies 51, 72, 76 are shown powered by motors 46, 47, 49 to produce a broad and even air flow into the main housing 2 through apertures 26. Two radiant heaters are shown 59, 72 although more may be incorporated to produce a broad and even heat source for air to pass over and through apertures 26.

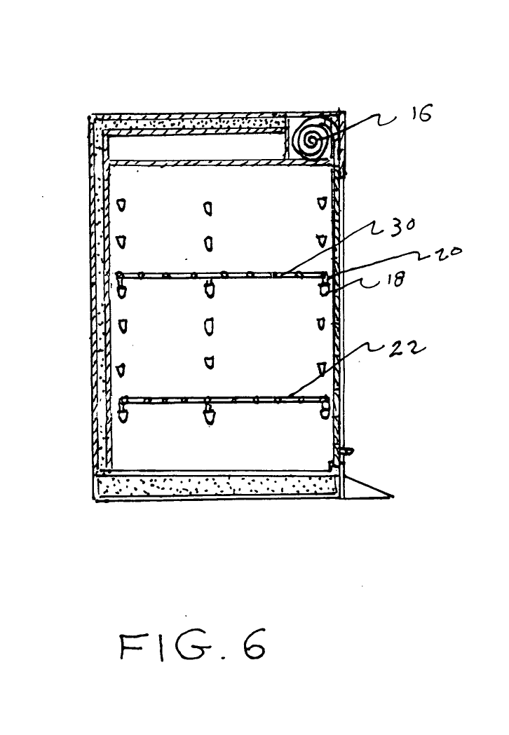

FIG. 6 shows a side section view as defined by section line 70 shown in FIG. 2. This view clearly shows roll up door 16 in its rolled position, as well as the regularly spaced receptacles 18 that allow the posts 20 of wire shelves 22, 30 to be supported.

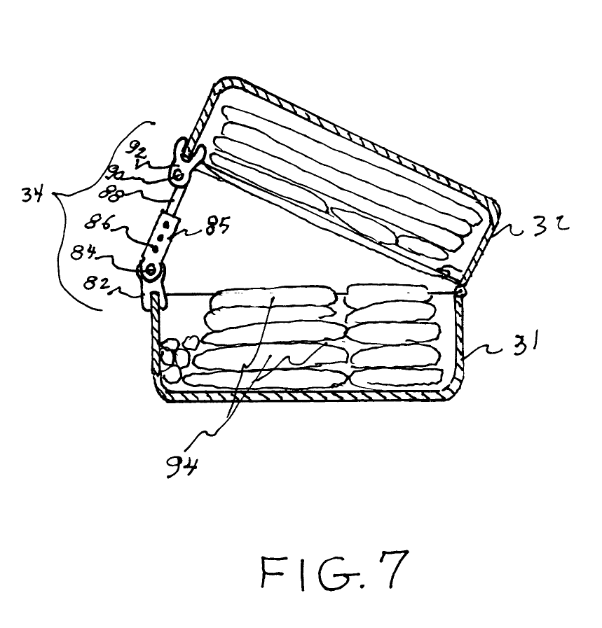

FIG. 7 shows an enlarged section view that bisects a standard suitcase comprised of a top half 32 and a bottom half 31. The brace assembly 34 is comprised of a pair of U shaped members 82, 92. U shaped member 82 is pinned 84 to a hollow tube 85 having a plurality of apertures 86. U shaped member 92 is pinned 90 to rod 88 which has a spring biased upwardly disposed post within it that can engage one of the apertures 86 in tube 85 for height adjustment purposes. One or more braces may be used per suitcase. The partially opened suitcase 31, 32 allows heat to quickly and easily enter and to permeate the contents 94 of the suitcase quickly. The entire bed bug killing event can then happen within approximately one minute.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. heated enclosure for killing bed bugs located within luggage comprising:
a first rectangular housing;
a roll up door located at the front of said first housing;
a second housing;
said second housing fixedly attached to the side of said first housing;
at least one second housing wall being vented to allow for the inflow of air into said second housing;
said first housing capable of removably retaining a plurality of luggage items;
a perforated vertical wall separating said first housing from said second housing;
said first housing having a plurality of post receiving receptacles fixedly attached and evenly spaced along said housing's inner side walls;
said post receiving receptacles capable of receiving a plurality of wire form trays;
each said tray capable of holding one or more items of luggage or suitcases;
said second housing enclosing a plurality of heating elements and a plurality of tangential blower fan assemblies;
said second housing also enclosing a thermostat, a digital timer circuit, an LED display, an indicator light on off switch and safety switch and
a power cord and plug which provides power from a wall socket to said the said electrical components located within said second housing.

2. heated enclosure for killing bed bugs located within luggage as claimed in claim 1 wherein said possible heating elements include thermal heating elements, infrared heat, ceramic heat convection heat tubes or any combination of these said heating devices.

3. heated enclosure for killing bed bugs located within luggage as claimed in claim 1 wherein said first housing is constructed of sheet metal and lined inside with insulation.

4. heated enclosure for killing bed bugs located within luggage as claimed in claim 1 wherein said heating devices act to bring the internal temperature inside said housing to 130 degrees F. within sixty seconds.

5. heated enclosure for killing bed bugs located within luggage as claimed in claim 1 wherein said roll up and down door is insulated allows easy entrance and exit of said luggage items.

6. heated enclosure for killing bed bugs located within luggage as claimed in claim 1 wherein said tangential blower assemblies draw air in through said vents in said second housing and pass said air evenly over said heating devices creating a flow of heated air;
said heated air passing through said perforated vertical wall separating said first housing from said second housing and into said luggage items within said first housing thereby killing any bed bugs that may reside in said luggage items.

7. heated enclosure for killing bed bugs located within luggage as claimed in claim 1 wherein digital timer circuit automatically turns off said heater devices and said fans after a predetermined period of time and turns on said indicating light showing that the process is complete

8. heated enclosure for killing bed bugs located within luggage as claimed in claim 1 wherein said LED display shows the amount of time remaining for each bug killing event.

9. heated enclosure for killing bed bugs located within luggage comprising:
a first rectangular housing;
a roll up door located at the front of said first housing;
a second housing;
said second housing fixedly attached to the side of said first housing;
at least one second housing wall being vented to allow for the inflow of air into said second housing;
said first housing capable of removably retaining a plurality of luggage items;
a perforated vertical wall separating said first housing from said second housing;
said first housing having a plurality of post receiving receptacles fixedly attached and evenly spaced along said housing's inner side walls;
said post receiving receptacles capable of receiving a plurality of wire form trays;
each said tray capable of holding one or more items of luggage;
said second housing enclosing a plurality of heating elements and a plurality of tangential blower fan assemblies;
said second housing also enclosing a thermostat, a timer circuit, an LED display, an on off switch and safety switch;
said suitcases or said luggage items held partially open by means of one or more adjustable braces;
the first end of said brace having a U shape and engaging the top edge of the side wall of the bottom half of said suitcase and the opposite end of said brace having a U shape that engages the bottom edge of the side wall of the top half of said suitcase;
said brace body having two telescoping tubular members slidably locking together, one said tube having a standard spring biased bullet shape that engages one of a plurality of equally spaced apertures located in the said second tube allowing the length of said brace to be adjusted.
